(19) United States
(12) Patent Application Publication
(10) Pub. No.: US 2024/0220944 A1
(43) Pub. Date: Jul. 4, 2024

(54) METHOD AND SYSTEM FOR SECURE DIGITAL PAYMENT SPLIT BETWEEN ON-ORDER AND ON-DELIVERY

(71) Applicant: Ehab Mohamed Ibrahim EL-KERSH, Alexandria (EG)

(72) Inventor: Ehab Mohamed Ibrahim EL-KERSH, Alexandria (EG)

(21) Appl. No.: 17/925,701

(22) PCT Filed: Nov. 16, 2021
(86) PCT No.: PCT/IB2021/060613

§ 371 Date: May 25, 2023

(51) Int. Cl. G06Q 20/06; G06Q 20/02; G06Q 20/10; G06Q 20/12; G06Q 20/36; G06Q 20/42

(52) U.S. Cl. CPC G06Q 20/065; G06Q 20/027; G06Q 20/10; G06Q 20/12; G06Q 20/36; G06Q 20/42

(57) ABSTRACT

Solutions in the field of digital payments using e-wallets, cards, or any digital payment methods; and in particular, to e-commerce online payments are provided. In e-commerce field, customers prefer full payment on-delivery after checking delivered goods; this introduces risk on merchants. In contrast, merchants prefer to process the full payment on-order before sending the shipment; this introduces risk on customers. Both options of full payment on-order or full payment on-delivery are not satisfactory or making fairness for both parties (customers and merchants). A solution for having a payment method that can automatically split the payment amount, based on a payment-split policy that merchant offers and customer accepts, to enable merchants to get part of the payment on-order then claim the rest of payment on-delivery is also provided.

### CROSS-REFERENCE TO RELATED APPLICATIONS

This application claims priority to PCT Application No. PCT/IB2021/060613, having a filing date of Nov. 16, 2021, the entire contents of which are hereby incorporated by reference.

### FIELD OF TECHNOLOGY

The following relates to the field of digital payments using e-wallets, cards, or any digital payment methods; and in particular, to method and system for processing digital payments for e-commerce online orders, upon order-placement and/or order-delivery, based on agreed payment policy.

### BACKGROUND

With the increased availability of smart devices and high-speed internet, there has been an exponential growth in the number of customers utilizing e-commerce platforms to purchase goods and services online. There are various payment modes that a customer may opt for in order to purchase goods and services from an e-commerce merchant. The customer may prepay the transaction amount online while placing the order, such that, a digital payment is made by the customer, via, one or more of credit card, debit card, a digital wallet, or a bank account. If delivered order is damaged or missing some items, customers suffer from problems in long processes for return and/or refund.

Alternatively, the customer may choose the ‘cash on delivery’ payment mode while placing the order. In this case, the customer completes the transaction only after receiving the goods or services by paying in cash upon delivery. Though the ‘cash on delivery’ payment mode is the choice of most e-commerce customers, this payment mode causes multiple problems for the e-commerce merchants and the customers. Some of these problems include, cash handling cost, cash and order reconciliation hassles, delay in receipt of cash, losses incurred in cash management, and exact cash requirements from the customers, also merchants have shipment cost problems in case of customer returns the order without payment.

### SUMMARY

An aspect relates to a method and system that retains the benefits of the ‘cash on delivery’ payment mode, while eliminating all the above discussed problems and achieving fairness between customers and merchants.

### BRIEF DESCRIPTION

Some of the embodiments will be described in detail, with references to the following Figures, wherein like designations denote like members, wherein:

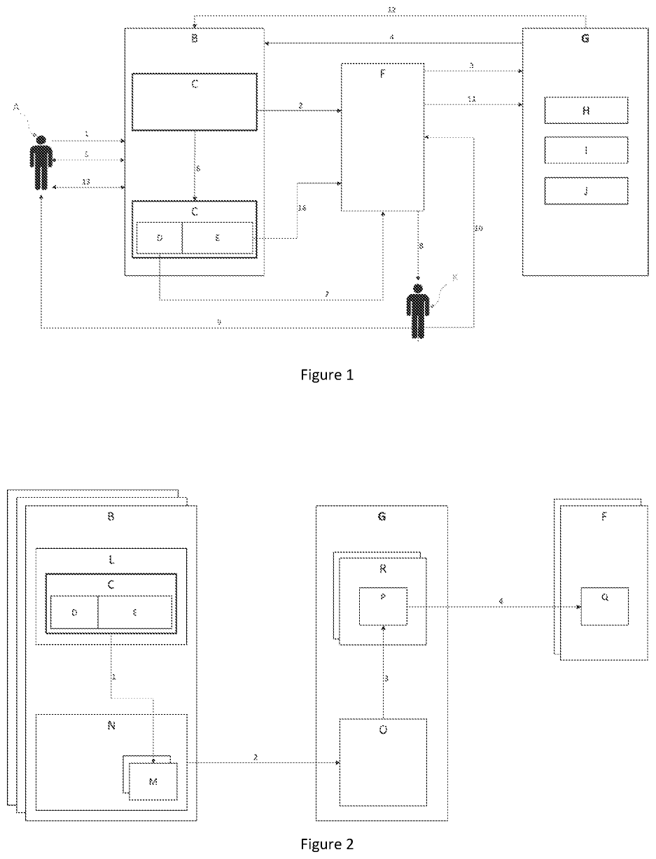

FIG. 1 illustrates a digital payment processing method, based on a payment-split policy, according to certain embodiment of the present invention;

FIG. 2 shows a flow diagram detailing the actual payment transfer from customer to merchant according to certain embodiment of the present invention;

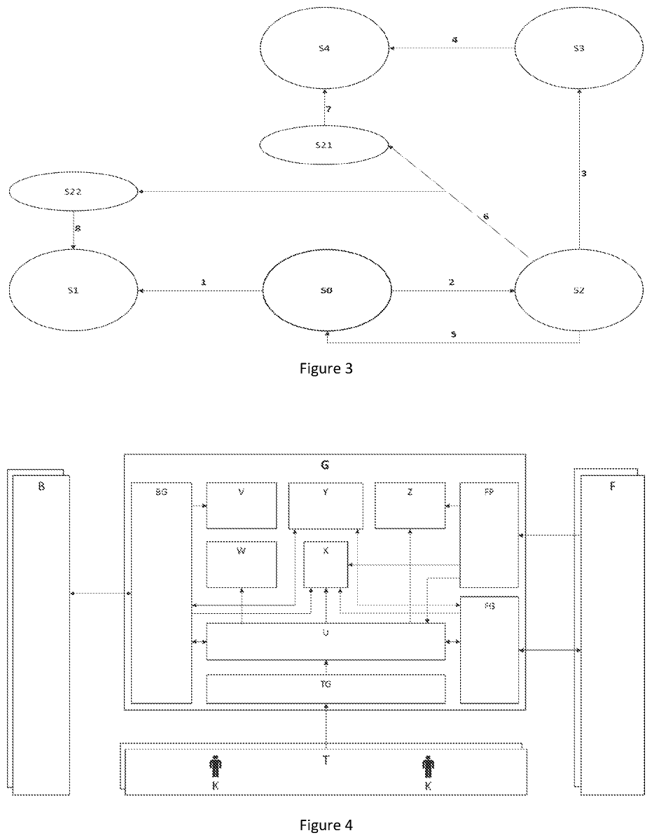

FIG. 3 shows a state-machine describing the digital payment hold management with multi-hold technique according to certain embodiment of the present invention; and

FIG. 4 depicts the payment network system that connects e-wallets, merchants, and carriers to implement embodiments of the invention method.

### DETAILED DESCRIPTION

### A. Problem Definition

The problem addressed by embodiments of the present invention is a complex problem that has characteristics from different, but related, perspectives.

For e-commerce online purchasing, customers prefer to pay on-delivery to mitigate the risk of paying upfront then receiving incorrect orders and going into refund process. E-commerce customers and also merchants prefer cashless payments to avoid cash problems mentioned in the “Background” section. Customers prefer to pay by their favourite e-wallets instead of cards that are not secure enough (millions of fraud cases per year). Customer preference to pay on-delivery conflicts with merchant preference.

Merchants do prefer online digital payments, before they ship orders, to receive the money earlier and to limit order returns that happen due to many reasons (customer is no longer interested in the order, customer is not available to receive the order, etc.). Although, merchant has no mistake in these cases, they lead to big money loss to merchant due to costs of shipping the order to customer and back, and many other handling and administrative costs.

This problem has the following characteristics:

1. From business perspective, full payment on-order is not fair for customers, and full payment on-delivery is not fair for merchants; so, a solution is needed to satisfy both parties.

2. From wallets perspective, while the world currently has thousands of wallets and the number is growing every day, only very few ones have global acceptance, and the rest use generated virtual cards to enable their users to purchase online. So, a solution is needed to connect any wallet to global merchants easily so any customer can use any wallet to pay for any merchant.

3. From security perspective, the few wallets that have global acceptance are based on cards inside (credit/debit or any kind of cards). Some of those wallets share the card information with merchants which is not secure, others like PayPal get the order information and withdraw the required amount directly from the customer's card then transfer the amount to the merchant without sharing card information. This solution fulfils the security requirement but does not reach the fairness between customer and merchant because it pays full amount on-order.

4. From delivery perspective, in most cases, merchants do not deliver themselves, they make use of specialized delivery companies like Aramex, FedEx, etc., and not all their delivery agents have Point-Of-Sale [POS] devices to accept digital payments by wallets. Even if the delivery agent has a POS device, it facilitates full on-delivery payments only that does not satisfy the fairness requirement.

5. From customer experience perspective, customers want to use the same wallet for online, on-delivery, and in-store purchases in a consistent way. For online purchases, customer needs to have a single transaction per purchase; so, if a solution proposes that customer should make two transactions for an online purchase (one for on-order and another for on-delivery) to achieve the desired fairness, this implicates bad customer experience, also it does not guarantee the on-delivery payment for the merchant.

It can be easily deduced from the analysis above that the addressed problem is not only technical or only business; rather, it is a combined problem where there are set of business needs while the current technology and solutions are unable to cover the set of needs together.

### B. Solution Method

Embodiments of the present invention solution method is based on Three Main Ideas hereunder:

1. Payment-Split Policy [PSP]:

This policy determines the percentage or the amount of money required by the merchant to be paid on-order (at order placement time), and the rest of percentage or amount that will be paid on-delivery of the order. For example, the PSP could be 10%-90% that means 10% of the total order value should be paid on-order and 90% will be collected on-delivery. Alternatively, it can be by exact amount not percentage; like 10-90 if the order value is 100 USD, this means 10 USD will be paid on-order and 90 USD on-delivery. In short, only the on-order split could be mentioned and the rest is deduced; this means if the merchant set the PSP to 10%, the method and system should automatically interpret it as 10% on-order and 90% on-delivery.

The merchant is free to decide different PSPs based on his own business rules/parameters like the product category, order value, customer segment, country, and so forth. The PSP could be set one-time or determined per order; if both are provided, the latter will supersede.

### 2. Prepared-Payment Reference [PPR]:

Customer can pay using credit in his credit card account, money in a bank account, money in an e-wallet, loyalty points in a loyalty account, or any other type of account balance. Any of the accounts have a controlling system, for example, if the customer payment account is a credit card account, so the controlling system is the card's issuer-bank system. If the payment account is an e-wallet account, so the account controlling system is the e-wallet system, and so forth.

The PPR is a fully qualified reference for a Prepared-Payment [PP]; in other words, it's a global unique identifier that contains a full address for the PP. A payment is considered prepared when the controlling system of the customer account puts the payment amount on-hold, and the receiver for this payment is determined. For example, if a customer wants to place an order of value 100 USD on a certain merchant website, and wants to use his money in an e-wallet to pay for this order, he should use the e-wallet to select the merchant as a receiver for the payment and set the amount to pay to 100 USD, so the e-wallet system will prepare the payment by holding the amount for the merchant and generate a unique reference for this PP. This way, when the customer gives the PPR to the merchant, the payment is guaranteed (by the e-wallet system) for the merchant but not processed yet. Later, the merchant uses the PPR along with the PSP to collect the payment amount according to embodiments of the present invention method.

### 3. Multi-Hold Technique [MHT]:

The multi-hold is a new technique to manage how to hold a payment amount and how to release it between a number of parties. In the context of embodiments of the present invention, the focus is on the PP hold and release between customer and merchant. The PP when created, it has one hold that is customer-hold [CH], so if the customer wants to cancel it before he gives its PPR to merchant, the hold will be removed and the amount will be available again to customer. If a PPR (with no cancellation) is given to merchant and that merchant sends it to the issuer system (e.g., e-wallet system), the system adds the second hold on the PP that is the merchant-hold [MH].

At this state, the PP amount will not be released to any of the parties without agreement from the other party. This means, for the merchant to collect the payment amount, customer should remove his CH, this happens for example when the order is delivered and the customer accepts it. The full hold/release lifecycle for PP will be explained in greater details later in this section.

### Payment Network Overview:

The three ideas above can be applied between a merchant or more and a customer using any digital payment method (credit card, e-wallet, etc.). For example, an e-wallet could integrate directly with several merchants and apply the PPR generation to give it to any of the merchants then apply the merchant's PSP and the MHT to release the payment to the merchant at the end of the payment process.

Direct connection between e-wallets and merchants is not an efficient solution because in this case:

1. Each e-wallet has to implement the whole solution with its merchant network, this could lead to having many different solutions with no responsible party to standardize or unify. This increases the cost on e-wallet systems, hence limits their reach to large number of merchants.

2. If a merchant wants to work with many e-wallets, this merchant should integrate with each e-wallet separately. This increases the cost on any merchant to support more e-wallets, and forces the customer to use the few e-wallets that have global reach, hence limits the agility and dynamicity of the e-commerce business.

The solution is to have a payment network that connects e-wallets to merchants and vice versa easily in a consistent way. What any e-wallet needs to do to reach to the whole network of merchants is to join this payment network and conform to its standards. Also, what any merchant needs to do to support all e-wallets is to join the same payment network and conform to its standards. Because many merchants deliver order shipments via delivery carriers, this network also supports having the carriers.

The preceding description of solution does not mean that embodiments of the present invention is limited to it; rather, as mentioned the main ideas are applicable in many ways to support the payment split between on-order and on-delivery. Any solution that uses the three main ideas together or separately is considered a variation within the scope of embodiments of the present invention.

### The Method:

FIG. 1 illustrates a payment scenario according to the embodiment of the present invention:

1. The method starts when a Customer (A) wants to checkout an order on the website or application of the Merchant (F). At the checkout payment step in the merchant's application, the customer chooses the e-wallet payment method and selects the e-wallet he wants to pay with; the merchant must be one of Registered Merchants (H) in the Payment Network (G), and the e-wallet must be one of Registered E-Wallets (I) in same network. Customer goes to his E-Wallet (B), determines (1) the merchant he wants to pay for, and the total order amount, then confirm.

2. E-Wallet (B) creates a Prepared Payment (C), applies the customer-hold on the PP, generates its PPR, and returns it to customer, then customer sends (2) the PPR to Merchant (F) via merchant's application/website.

3. Merchant (F) decides the payment-split policy based on his business rules, then sends (3) both PPR and PSP to Payment Network (G)

4. Payment Network (G) forwards (4) the PPR and PSP back to E-Wallet (B). Note: PPR as described before is a fully qualified reference for the PP including the e-wallet identifier so the payment network can determine the issuer e-wallet and forward the PPR to it.

5. E-Wallet (B) notifies Customer (A) to confirm his acceptance for the merchant's PSP. When customer confirms (5), the e-wallet applies merchant-hold on the PP.

6. E-Wallet (B) splits (6) the PP (C) based on the PSP into on-Order Payment (D) and on-Delivery Payment (E).

7. E-Wallet (B) removes customer-hold from the on-Order Payment (D) based on customer acceptance for PSP, then transfers (7) the on-Order Payment (D) to Merchant (F). The transfer actually takes place via the Payment Network (G) as described later in details.

8. Merchant (F) executes the order shipment process, and gives (8) the shipment to the Carrier's Agent (K) to deliver it to Customer (A).

9. Agent (K) delivers (9) the shipment to Customer (A).

10. Agent (K) sends (10) an order delivery note to Merchant (F). The delivery note could be sent via a merchant's application, or carrier's application that integrates with merchant's system. Alternatively, Agent (K) can send the delivery note directly to Payment Network (G), then the network forwards the note to merchant. The advantage of the alternative scenario is that in case the carrier delivers shipments on behalf of many merchants, it's better to integrate only with the network instead of integrating with all the merchants. In this case, the carrier should be one of the Registered Carriers (J) in the Payment Network (G) to be able to integrate with the network.

11. Merchant (F) forwards (11) the delivery note along with the order's PPR to Payment Network (G) to collect the on-Delivery Payment (E).

12. Payment Network (G) forwards (12) the delivery note along with the PPR to customer's E-Wallet (B) to collect the merchant's on-Delivery Payment (E).

13. E-Wallet (B) notifies Customer (A) to confirm his acceptance for the order shipment. When customer confirms (13), the e-wallet removes customer-hold from the on-Delivery Payment (E).

14. E-Wallet (B) transfers (14) the on-Delivery Payment (E) to Merchant (F). The transfer actually takes place via the Payment Network (G) as described hereunder.

### Payment Transfer Flow:

In Method steps (7) and (14), an amount of money should be moved from customer to merchant.

FIG. 2 illustrates a typical flow for money transfer from customer to merchant via payment network:

1. E-Wallet (B) that contains/controls Customer Account (L), transfers (1) a part of PP (C) to an E-Wallet Account (N) that is designated for Payment Network (G). Any e-wallet registered in the payment network must create an internal account for the network. The PP-transferred payment-part can be the on-Order (D) or the on-Delivery (E); the transfer flow is the same for both cases. E-Wallet (B) transfers required payment to Account (N) by creating a credit record into the account specifying the PPR, the payment amount, and the Merchant ID (M). All e-wallets in the network continue to do this kind of transfers for all payments for all merchants for a specified time interval, for example one full day, before the e-wallets perform the second step.

2. E-Wallet (B) transfers (2) the aggregate balance for the whole day from Account (N) to the Network Aggregate Account (O); this transfer is a real money transfer from the financial system of the E-Wallet (B) to the financial system of the Payment Network (G). Network Aggregate Account (O) receives the daily payment transfers from all registered e-wallets to forward them to their target registered merchants; this means that the account (O) contains the whole network payments for one day.

3. Payment Network (G) has an internal Merchant Account (P) for each Registered Merchant Record (R). Payment Network (G) groups the whole daily payments per merchant, then transfers (3) each group of payments to its Merchant Account (P).

4. Payment Network (G) transfers (4) the total amount of the daily merchant's payments in the network-internal Merchant Account (P) from the network financial system to the Real Merchant Account (Q) in the financial system of the Merchant (F). Note: merchant real account is part of the record of any registered merchant.

This description assumes separate financial systems for the three main entities (e-wallet, payment network, and merchant). If this solution is implemented using digital-currency accounts on a blockchain platform for example, the transfers should be much easier and could have shorter intervals, or even performed instantly for a payment by payment, but it must be via the payment network anyway to deduct its fees before forwarding the payment to the merchant. Also, e-wallets deduct their fees before they transfer the payment amounts to the payment network.

### Method Exceptional Scenarios (Order Rejection Scenarios):

FIGS. 1 and 2 illustrate the normal scenario where the customer accepts the whole order shipment. There are some other cases like, the order is totally wrong, or some order items are missing or damaged. In all these cases, customer rejects the merchant's request to claim the on-delivery payment. The payment network notifies the merchant about customer rejection, so merchant can contact the customer and handle the issue according to a certain process that differs from merchant to merchant and it's out of scope of embodiments of the present invention.

After reaching an agreement with the customer, the merchant takes an action on the payment network to apply the agreed settlement with customer. Merchant actions differ based on the situation as follows; assuming that collected on-order payment is 100 USD and the remaining on-delivery payment is 400:

### 1. Customer Rejected the Whole Order or Cancelled Order Before Shipment:

a. Merchant removes his hold on the on-delivery payment to be released to customer.

b. Merchant refunds the on-order payment or part of it to customer according to the merchant's refund policy. Refund policy could be part of the PSP, for example in this case the PSP is 20%, if the merchant has non-refund policy of 10% (non-refund must be at most equal to on-order split), so the PSP will be 20%−10%. The payment network interprets the PSP as 20% on-order, 80% on-delivery, and 10% non-refundable. The network should not take any action based on the non-refundable part, it's only to be forwarded to customer with the PSP to agree on before the payment proceeds.

2. Customer Rejected the Order Partially (Value of Accepted Part is More than On-Order Payment):

a. Merchant claims the on-delivery payment partially as final claim. For example, if customer accepted part of the order that has a total value of 300 USD, merchant claims 200 out of the remaining 400 because 200+100 (on-order payment)=300.

Final claim: Sometimes, in normal cases, merchants deliver big orders in separate shipments and prefer to claim payments per shipment, so a merchant could claim multiple partial (but not final) on-delivery payments. This is why in this rejection case, partial claim must be flagged as final, so the e-wallet can release the remaining 200 to customer (400−200=200).

3. Customer Rejected the Order Partially (Value of Accepted Part is Less than On-Order Payment):

a. Merchant removes his hold on the on-delivery payment to be released to customer.

b. Merchant refunds the difference between the on-order value and the accepted order value according to the merchant's refund policy. Assuming policy allows, if customer accepted order part value is 80 USD, so merchant should refund 100−80=20.

To wrap up the set of actions that merchant could take in all described scenarios, merchant claims full payment in normal case, claims partially if customer rejected some items, claims zero and refund whole/part of on-order payment if customer rejects whole/most of order. This means it's either for the merchant to Claim full/partial/zero on-delivery payment, Refund full/partial on-order payment, or both.

### Payment Claim Cases:

FIG. 3 illustrates all claim cases according to the Multi Hold Technique [MHT] as follows:

1. When any payment prepared, it is created (method step 2) in a Customer-Hold [CH] state (S0). If the customer cancels (1) the payment, it moves to Released-to-Customer state (S1).

2. From (S0), if customer gives PPR to merchant, merchant sends it back to e-wallet, and customer confirms PSP (method step 5), the system adds (2) Merchant-Hold [MH] to the payment to be in state (S2) CH-MH.

3. When customer confirms delivery after receiving the shipment in normal case (method step 13), the system removes (3) the CH from the payment and moves it to state (S3) MH.

4. System automatically releases (4) the payment to merchant (method step 14) and moves it to state (S4) Released-to-Merchant.

5. In case of exceptional scenario where merchant will not claim the on-delivery payment, merchant should send claim with zero amount or percentage to the payment network (method step 11), so the system removes (5) MH from the payment, moves it from (S2) back to state (S0) CH, then notify the customer, so customer can cancel it anytime to get his money released according to point 1.

6. In case of exceptional scenario where merchant will claim the on-delivery payment partially, merchant claims the desired amount (method step 11) with final-claim flag. After customer confirmation (method step 13), the system splits (6) the payment in (S2) into two parts; the claimed part for merchant and the rest of amount for customer. The merchant part will be in state (S21) MH, and customer part will be in state (S22) CH.

7. The system automatically releases (7) merchant part to merchant (method step 14) and moves it from (S21) to state (S4) Released-to-Merchant.

8. The system automatically releases (8) customer part to customer and moves it from (S22) to state (S1) Released-to-Customer.

If final-claim flag is not set, the system splits payment in (S2) into (S21) MH then release it to merchant, and the rest of amount will remain in (S2) waiting for further merchant claims. Nothing should be returned to customer until the final-claim flag is set in the merchant's request.

### Payment Refund Approaches:

As mentioned in the Payment Transfer Flow description, the solution can be implemented using digital currency accounts on a blockchain platform, so transfers can be performed instantly for each payment. Based on that, refund in such implementation can follow same flow in FIG. 2 but in opposite direction:

1. Merchant issues a refund transfer from his account to the payment network account, the transfer should be accompanied with the PPR of the payment that is being refunded.

2. Given the PPR, the payment network can get its detailed information including the issuer e-wallet, then issue a transfer from network account to e-wallet account (e-wallet account is part of any registered e-wallet record).

3. The issuer e-wallet internally transfer the refund amount it received to the account of the customer owning that PPR.

If the solution is implemented using separate traditional financial systems for the three main entities (e-wallet, payment network, and merchant), the refund scenario can be as follows (referencing FIG. 2):

1. Merchant (F) issues a refund order to the Payment Network (G) accompanied with the PPR and refund amount (no transfer here).

2. The Payment Network (G) records the refund order as a debit record in the Merchant's Account (P) within the network. Then the network issues a refund order with the same amount to the E-Wallet (B) that issued the PPR (no transfer here also).

3. The e-wallet records the refund order as a debit record in the Network's Account (N) within the e-wallet system, indicating the Merchant ID (M). Then the e-wallet credits the PPR-owning Customer Account (C) by the refund amount. This way, once the merchant issues the refund, the customer receives the amount immediately.

4. To close the cycle, when the next day comes, the e-wallet transfers (2) the daily net balance to Network Aggregate Account (O). The net balance equals the total payments amount of the day minus the refund debit amount.

5. Payment Network (G) transfers (3) total merchant's payments of the day to his Account (P), then transfers (4) the net balance of Account (P) to Real Merchant Account (Q). Account (P) net balance equals the total merchant's payments amount minus the refund debit amount.

In case of order return, merchant could take time to receive and inspect it, this time depends on merchant's internal process that is out of scope of embodiments of the present invention. Refund approaches described above guarantee that the customer receives the refund amount once the merchant issues a refund order.

Note: Same approaches are applicable for refund anytime, even after 100% payment collection for merchant, customer can contact merchant to return whole/part of order and if merchant accepts, merchant issues a refund order/transfer to payment network according to any of the approaches above.

### C. Solution Advantages Over Background Art

1. Fairness: the solution of embodiments of the present invention balances between merchant need to trust the payment, and customer need to trust the delivery, using the MHT applied by a third party (the combination of e-wallet/payment-network). This combination is not a customer party or a merchant party; it's a fair third party. In case of dispute, the MHT encourages both merchant and customer to reach an agreement because without such agreement, the payment will go to neither of them. Also, having an agreed PSP between merchant and customer is another fairness/trust tool that gives the merchant a certain degree of control for risk mitigation of shipment cost losses, and cash flow bottlenecks (cash flow does not mean cash payment, it's a term about the time and rate of incoming money), while it gives the customer the freedom to accept or reject and compare between merchants who compete to provide better PSPs.

2. Security: embodiments of the present invention solution guarantee a 100% secure digital payment due to the notion of PPR. PPR does not contain any information regarding customer account or card, it's a reference for a prepared payment to a specific destined merchant. So, nobody can manipulate it; even if sniffed or hacked, the hacker has no way to use it to get money. If customer has a bank account and uses the e-wallet of that bank, he doesn't need a card or PayPal wallet or anything else to perform a 100% secure payment without sharing account information with any party; if the e-wallet of customer bank registered in the payment network, customer can pay to any merchant in the same network using PPR generated from his bank e-wallet.

3. Decoupled connectivity: the payment network connects any registered e-wallet to any registered merchant while applying full decoupling; e-wallets don't depend on merchants and merchants don't depend on e-wallets. Merchants and e-wallets depend only on the payment network. Payment network and e-wallets don't have to know any order details (in conventional solutions like PayPal, the e-wallet depends on merchants to get the order information). Embodiments of the present invention solution enable any e-wallet (not only the few global ones) to pay securely for any merchant without the need for a virtual card that is not fully secure.

4. Three-Party Network: in addition to connecting merchants and e-wallets in a decoupled way, the payment network connects delivery carriers to merchants in a decoupled way. If a carrier system is already coupled with a merchant system, the network can support this scenario also, as described in the Method step 10 that carrier can send delivery note to the network or to merchant directly.

5. No POS: the agent of the delivery carrier does not need to have a POS to collect digital payment.

6. Immediate Refund: as described thoroughly in Payment Refund Approaches section, customer account gets credited immediately, once the merchant issues the refund order/transfer.

7. Customer Experience:
a. customer can see the hold in his account, no money movement to another account for merchant or third-party, until the payment gets collected after his acceptance.
b. At delivery time, customer can postpone delivery confirmation till he checks all order items; delivery agent doesn't have to wait, he can send the delivery note and move.
c. Customer can use the same payment method consistently for other types of payment:
i. If merchant does not mandate to get PPR at order placement time, customer can generate it on-delivery and share it with carrier agent to send it, on behalf of merchant, to the payment network to claim the payment. PPR can be shared to agent as number to insert in agent's application or as a QR code to scan it.
ii. In store, customer can generate PPR and share it with the merchant's cashier application also as number or QR code, so the application sends it to the payment network to claim the payment.

A flag for “instant full payment” can be added to bypass payment split and delivery confirmation.

### Best Mode for Carrying Out Embodiments of the Invention

FIG. 4 illustrates the Payment Network System [PNS] (G) components and integrations that facilitate carrying out embodiments of the present invention method.

### PNS Integrations & Components:

PNS integrates three types of systems; e-wallet systems, merchant systems, and carrier systems. PNS provides a gateway for interaction with each type of systems and a set of core system components to support/serve the gateways as follows:

1. E-Wallet Gateway (BG): this is the system component responsible for all communication with all e-wallets including the e-wallet registration in PNS and all interactions during payment and refund scenarios. This component depends on E-Wallet (B) and other PNS components:

a. Payment Orchestrator (U): this is the main system component that manages workflows for all payment and refund scenarios; the gateway (BG) depends on it during the scenarios; for example, when notifying PNS about customer delivery confirmation.

b. Query Engine (X): this is a generic query tool that provides any component with any data it needs from the datastore. The gateway (BG) depends on it to get the list of registered merchants to display to customer to select one for payment preparation.

c. Reconciliation Engine (Y): this is the component responsible for cross checking the recorded payments versus transferred amounts. It gets notified by e-wallets after daily transfer to start cross checking. In case of any inconsistency, it notifies the e-wallet back to resolve the issue.

d. PPR Generator (V): this is a centralized component responsible for unifying the format of generated PPR across all registered e-wallets; therefore, e-wallets depend on it to get a PPR during payment preparation. Alternatively, e-wallets can generate PPRs based on agreed format without referring to the centralized component.

2. Carrier Gateway (TG): this is the system component responsible for all communication with all carriers; including the carrier registration in PNS, and receiving the delivery notification during the payment scenario; the notification gets sent by an Agent (K) via the Carrier System (T). This component depends on another PNS component:

a. Payment Orchestrator (U): this is the main system component that manages the workflow for all payment and refund scenarios; the gateway (TG) depends on it for handling the on-delivery payment collection based on the delivery notification.

3. Merchant Gateway (FG): this is the system component responsible for all communication with all merchants including the merchant registration in PNS and all system-to-system (i.e., PNS-to-merchant system) interactions during payment and refund scenarios. This component depends on Merchant (F) and other PNS components:

a. Payment Orchestrator (U): this is the main system component that manages the workflow for all payment and refund scenarios; the gateway (FG) depends on it during the scenarios; for example, to collect on-order and on-delivery payments for merchant.

b. Query Engine (X): this is a generic query tool that provides any component with any data it needs from the datastore. The gateway (FG) depends on it to get the list of registered e-wallets to display to customer to select one to pay with.

c. Reconciliation Engine (Y): this is for cross checking the recorded payments versus transferred amounts. It notifies merchants after daily transfer to start cross checking. In case of any inconsistency, it gets notified back by merchant to resolve the issue.

4. Merchant Portal (FP): this is a system visual component to support Merchant (F) for reporting on and monitoring payments, setting PSP business rules, assigning carriers to claim on-delivery payments on behalf of the merchant, etc. This component depends on other PNS components:

a. Payment Orchestrator (U): this is the main system component that manages the workflow for all payment and refund scenarios; the portal (FP) depends on it; for example, to assign the carriers allowed to claim on-delivery payments on behalf of merchant (F).

b. Query Engine (X): this is a generic query tool that provides any component with any data it needs from the datastore. The portal (FP) depends on it to get the list of payments, the list of registered carriers, etc.

c. PSP Rule-Engine (Z): this is a generic optional rule engine that supports merchants to build their business rules that help them to decide different PSPs in different cases based on certain attributes. Merchants can use rules in their internal systems, use this optional engine, or use both.

5. Payment Orchestrator (U): this is the main system component that manages the workflow for all payment and refund scenarios. It depends on the gateways to interact with the three parties (e-wallets, merchants, and carriers). It also depends on other PNS components:

a. PSP Rule-Engine (Z): this is a generic rule engine that supports merchants to build their business rules that help them to decide PSPs. The orchestrator (U) depends on it in case the merchant did not send a PSP, that means the engine should be used to decide PSP.

b. Query Engine (X): this is a generic query tool that provides any component with any data it needs from the datastore. The orchestrator (U) depends on it to get e-wallet information, merchant information, carrier information, payment information, etc.

c. MHT Engine (W): this is a state management framework that has the MHT logic built-in. Orchestrator (U) depends on this engine to manage PP state using its PPR based on the actions received from E-Wallet (B) via the gateway (BG). This way, E-Wallet (B) is not required to build MHT logic inside its system as long as it is provided by the PNS. E-Wallet (B) does not change a PP state internally unless it gets changed in the engine (W) first then sent back to wallet (B) to change the PP state and act accordingly.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A Payment Network System PNS, for secure digital payment processing for electronic commerce, characterized by splitting the digital payment amount automatically into On-Order Payment and On-Delivery Payment, based on a Payment-Split Policy or PSP; the PNS also characterized by connecting the three parties; E-Wallets or electronic/digital wallets), Merchants' Systems, and shipment-delivery Carriers' Systems, involved in the processing of the payments; the PNS comprising components of:
a. E-Wallet Gateway, is responsible for all interactions with all E-Wallets;
b. Merchant Gateway, is responsible for all interactions with all Merchants' Systems;
c. Carrier Gateway, is responsible for all interactions with all Carriers' Systems;
d. Payment Orchestrator, for managing all payment processing workflows, interacting with the E-Wallets, Merchants' Systems, and Carriers' Systems via components (a, b, and c respectively);
e. Merchant Portal, for supporting Merchants to build/change PSP business rules, and assign Carriers to claim On-Delivery Payments on behalf of the Merchants;
f. PSP Rule-Engine, for executing the PSP business rules, built via component (e), and deciding the PSP;
g. Prepared-Payment Reference or PPR; Generator, for unifying the format of generated PPR across all E-Wallets;
h. Multi-Hold Technique or MHT; Engine, for managing the state transitions of the Prepared Payment or PP; according to the MHT;
i. Reconciliation Engine, for cross checking recorded payments and transferred amounts, between E-Wallets, PNS, and Merchants' Systems; and
j. Query Engine, for any query execution required by other PNS components.

2. The system of claim 1, wherein component ‘f’ decides a PSP for each PP; the PSP determines the PP percentage, or the amount of money, required by the Merchant to be paid On-Order, and the PP percentage, or the amount of money, required by the Merchant to be paid On-Delivery.

3. The system of claim 1, wherein component ‘g’ generates a PPR for each PP; the PPR is a global unique identifier that contains a fully qualified electronic-address for a PP; a Payment is considered Prepared when the controlling-system of the payer-account puts the payment amount on-hold with determination for the receiver of the payment.

4. The system of claim 1, wherein component ‘h’ manages PP state according to the MHT; the MHT enables multiple parties to add a hold for each party independently on the same PP; adding multiple holds on PP creates a multi-hold state for the PP; at the state, any of the parties can claim a whole/part-of the PP amount, the MHT mandates that the rest of parties must agree to remove their hold from the claimed amount to be released to the claiming party.

5. A method for secure digital payment processing for electronic commerce, characterized by splitting the digital payment amount automatically into On-Order Payment and On-Delivery Payment, based on a Payment-Split Policy or PSP, comprising:
a. setting payment attributes, wherein Customer uses an E-Wallet to prepare a payment for a Merchant to pay for an order; the Customer sets the payment amount and the receiving Merchant for the payment;
b. preparing the payment, wherein the E-Wallet creates a Prepared Payment, generates a Prepared Payment Reference or PPR, adds Customer-Hold or CH on the PP according to the MHT, and displays generated PPR to Customer, then the Customer submits the PPR to the receiving Merchant's system;
c. deciding PSP, wherein the Merchant's system decides a PSP for the order payment, then sends decided PSP along with the PPR to a Payment Network System or PNS;
d. sending PSP to E-Wallet, wherein the PNS forwards the PPR and PSP, received from the Merchant's system, back to the E-Wallet that had originally generated the PPR;
e. confirming PSP, wherein the E-Wallet notifies the Customer to confirm acceptance for the PSP; once confirmed, the E-Wallet adds Merchant-Hold; on the PP according to the MHT;
f. splitting PP, wherein the E-Wallet splits the PP into on-order payment and on-delivery payment based on Customer acceptance for the PSP;
g. collecting on-order payment, wherein the E-Wallet removes CH from the on-order payment according to the MHT, based on the Customer acceptance, then the E-Wallet makes a transfer of the on-order payment to the receiving Merchant; the transfer actually takes place via the PNS;
h. shipping order, wherein the Merchant gives the shipment to a Delivery Agent to deliver it to the Customer;
i. delivering order, wherein the Agent delivers the shipment to the Customer;
j. notifying Merchant about delivery, wherein the Agent sends a delivery note to the Merchant's system;
k. claiming on-delivery payment, wherein the Merchant's system forwards the delivery note along with the PPR to the PNS to collect the on-delivery payment;
l. sending delivery note to E-Wallet, wherein the PNS forwards the delivery note along with the PPR to the E-Wallet;
m. confirming delivery, wherein the E-Wallet notifies the Customer to confirm order acceptance; once confirmed, E-Wallet removes CH from the on-delivery payment according to the MHT; and
n. collecting on-delivery payment, wherein the E-Wallet makes a transfer of the on-delivery payment to the Merchant; the transfer actually takes place via the PNS.

6. The method of claim 5, wherein the E-Wallet makes payment transfer to the Merchant; the transfer actually takes place via the PNS, the flow of the transfer comprising:
a. E-Wallet transfers the payment from Customer's account to PNS-designated account in the E-Wallet; the payment specifies the receiving Merchant; the E-Wallet aggregates all payments in the PNS-designated account for a unified time interval, agreed between PNS, E-Wallets, and Merchants, till the interval expires;
b. E-Wallet transfers the aggregated balance for the whole interval payments from the PNS-designated account to the real PNS bank account;
c. PNS distributes the aggregated balance in the PNS bank account to Merchants' accounts in PNS, according to the payment records for each Merchant; and
d. PNS transfers the balances in the Merchants' accounts in PNS to the real Merchants' bank accounts.

7. The payment transfer of claim 6, wherein the normal flow of payment is from Customer's account in E-Wallet to Merchant but if the Customer decided to return the order, the payment needs to be refunded from the Merchant to the Customer's account; a refund flow, characterized by instant credit to the Customer's account, comprising:
a. Merchant issues a refund to PNS indicating the PPR and refund amount;
b. PNS records received refund as a debit record in Merchant's account in PNS;
c. PNS issues another refund with same amount to E-Wallet that had issued the PPR;
d. E-Wallet records received refund as a debit record in PNS-designated account in the E-Wallet indicating the Merchant;
e. E-Wallet credits PPR-owning Customer's account by the refund amount;
f. E-Wallet transfers the aggregated net balance in the PNS-designated account, after deducting the refund amount, to PNS bank account, this step takes place when the present time interval expires; and
g. PNS distributes the balance to Merchants' accounts in PNS, then transfers the net balance in the Merchant's account, after deducting the refund amount, to the real Merchant's bank account.

8. The method of claim 5, wherein step ‘j’ Delivery Agent sends a delivery note to Merchant's system; the step can take place via PNS if the Agent is a Carrier's Agent using Carrier's system to send the note to the PNS, then the PNS forwards the note to the Merchant's system.

9. The method of claim 5, wherein the three parties; E-Wallets, Merchants' Systems, and Carriers' Systems are interacting with PNS; the parties must be registered in the PNS to be allowed to participate in payment processing.
